(19) United States
(12) Patent Application Publication
(10) Pub. No.: US 2001/0020558 A1
(43) Pub. Date: Sep. 13, 2001

(54) Steering device for axles

(75) Inventors: Hermann Franzen, Monchengladbach (DE); Joachim Kroll, Juchen (DE); Janis Moutsokapas, Monheim (DE)

Correspondence Address: Thomas C. Pontani, Esq., Cohen, Pontani, Lieberman & Pavane, Suite 1210, 551 Fifth Avenue, New York, NY, 10176, US

(73) Assignee: Atecs Mannesmann AG

(21) Appl. No.: 09/798,494

(22) Filed: Mar. 2, 2001

(30) Foreign Application Priority Data
Mar. 2, 2000 (DE) 100 11 594.2

(51) Int. Cl. B62D 5/06

(52) U.S. Cl. 180/418; 180/400

(57) ABSTRACT

The invention relates to a hydraulic steering device for the chassis of a vehicle, in particular of a crane or transport vehicle, with chassis axles steerable between longitudinal and transverse drive positions and in each case fixed to a shaft on the vehicle that is pivoted about a vertical swiveling axle, on which shaft a steering cylinder acts by way of at least one laterally projecting control arm for swiveling of the shaft. The steering cylinder acting on the projecting control arm and a further steering cylinder acting on a vehicle frame beam are articulated to a lever arm, coaxially pivoted on the shaft, in such a way that the torsional movement of the shaft resulting from the retracting and extending movement of the two steering cylinders adds up to at least ±90°.

### BACKGROUND OF THE INVENTION

1. Field of the Invention

The invention relates to a hydraulic steering device for the chassis of a vehicle, in particular the chassis of a crane or transport vehicle, the chassis having axles steerable between longitudinal and transverse drive positions and in each case being fixed to a shaft on the vehicle that is pivoted about a vertical swiveling axle, on which shaft a steering cylinder acts by way of at least one laterally projecting control arm for swiveling of the shaft.

2. Description of the Related Art

A steering device of generic type for a multiaxle vehicle with all-wheel steering and drive is known from DE 23 32 243 C3. In this a relatively simple control mechanism with a device for adjustment of the axles between longitudinal and transverse drive positions is achieved in that independent adjusting members designed as double-acting hydraulic cylinders are articulated on control arms torsionally fixed to the axles and can be extended to a position corresponding to the axle position for transverse drive. At the same time the double-acting cylinders are in each case arranged between a fixed point on the chassis and the plate-shaped control arms torsionally fixed to the axles, the control arms each being swiveled through approximately 90° by the hydraulic cylinders. The axles are each coupled to one another by means of connecting rods, so that a common steering angle always results oil all axles. The solution known from DE 23 32 243D C3 has the disadvantage that due to the use of longitudinally unadjustable connecting rods only a fixed steering radius can be set.

Finally steering devices for multiaxle vehicles are also known in which the steering movement is brought about by slewing gears, swivel motors or swivel mechanisms. Although an individual steering angle of more than 90° can be achieved with these, the latter solutions are very expensive owing to the bearings required for the slewing gears and the costly mechanisms and motors.

### SUMMARY OF THE INVENTION

The object of the present invention is to improve a hydraulic steering device of the generic type cylinder articulation. The hydraulic steering device of the invention is of simple design but yet is very effective for the attainment of a steering angle of at least 180°, thereby giving vehicles an extreme maneuverability.

To achieve this object a steering device is proposed, which is characterized by a lever arm coaxially pivoted on the shaft, on which lever arm the steering cylinder, acting on the projecting control arm, and a further steering cylinder, acting on the vehicle, act in such a way that the torsional movement of the shaft resulting from the retracting and extending movement of the two steering cylinders is cumulative.

The new steering device achieves an independent, continuously variable steering angle of at least 180° for each axle by dividing the steering movement up into two steering planes. Used in crane carriers and transport vehicles it gives such vehicles an extreme maneuverability in the longitudinal and transverse directions of the vehicle. The proposed solution is a low-cost alternative to conventional drive systems such as slewing gears, swivel motors and swivel mechanisms and represents a low-cost alternative to the prior art that can also be used for heavy crane vehicles.

According to the invention it is proposed that in a first horizontal lower steering plane the end of the first steering cylinder remote from the control arm be fixed to the free end of a lever arm projecting in a plane parallel to the former, and that in a second horizontal upper steering plane parallel to the first steering plane the other steering cylinder be connected to the chassis frame, the control arm being capable of swiveling in relation to the lever arm and the lever arm in relation to the vehicle by at least ±45° in each case.

The steering device provides that the lever arm is articulated to the control arm in such manner that a rotative movement of the lever arm is replicated in the control arm resulting in an angular rotation of the shaft which is cumulative of angular movements of the lever arm and the control arm, i.e., 90° shaft rotation produced by a 45° rotation of each of the two arms.

Since each individual control arm is capable of swiveling through at least ±45° in its steering plane, only one, preferably the lower steering plane need be actuated for normal vehicle use and steering movements to change the direction of travel, while the second steering plane comes into play only when extreme steering angles or transverse drive are required.

According to a further feature of the invention, the control arm includes two wing flanges each projecting on one of two opposite sides of the shaft. Between the ends of the arms and the bearing arm, which in the starting position of the steering device extends transversely to the control arms, two double-acting steering cylinders, arranged symmetrically in relation to the longitudinal center plane through the bearing arm, act, as do two such similarly arranged cylinders between the chassis frame and the bearing arm. This proposal means that currently available low-cost hydraulic cylinders with relative short strokes can be used. The symmetrical arrangement means that the steering forces for the left-hand and right-hand steering angle are in each case distributed between two hydraulic cylinders.

In a further development of the invention it is proposed that the bearing arm be of plate-shaped design and supported on the shaft between the first steering cylinders and the further steering cylinders in both steering planes, the steering cylinders in the lower steering plane acting on the lower free end of the bearing arm and the steering cylinders in the upper steering plane acting on the upper area of the bearing arm close to the shaft. The lever may at the same time perform the function of the control arm, on which the hydraulic cylinders in the first plane act, while hydraulic cylinders in the second steering plane receive the freely projecting end of the lever.

The angular position of the axle can be detected by encoders assigned to each vehicle axle. Various pre-adjustable travel routes can be recalled from a computer program, the virtually unlimited steering possibilities of the vehicle allowing scope for any individual route. The solution according to the invention creates a low-cost steering device, which increases the economic efficiency of the vehicle.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1a is a side view of two axle groups of a vehicle provided with a steering device according to the invention, the axles being at a steering angle of 0°;

FIG. 1b is a top plan view of the two axle groups depicted in FIG. 1a with the chassis structure and frame beam above one of the axle groups not being shown;

FIG. 2a is a side view similar to FIG. 1a with the axle groups at a 45°, the steering angle;

FIG. 2b is a view similar to FIG. 1b, the steering angle beting 45°, the chassis structure and fame beams above the axle groups not being shown, portions of lever arms on the axle being cutaway, and the steering cylinders of the second upper plane of one axle group not being shown;

FIG. 3a is a view of the same as FIG. 2a except the steering angle of the axles is 90°;

FIG. 3b is the same as FIG. 2b, the steering angle being 90°; and

FIG. 4 is a vertical central sectional view through one of the swiveling axles.

### DETAILED DESCRIPTION OF THE PRESENTLY PREFERRED EMBODIMENTS

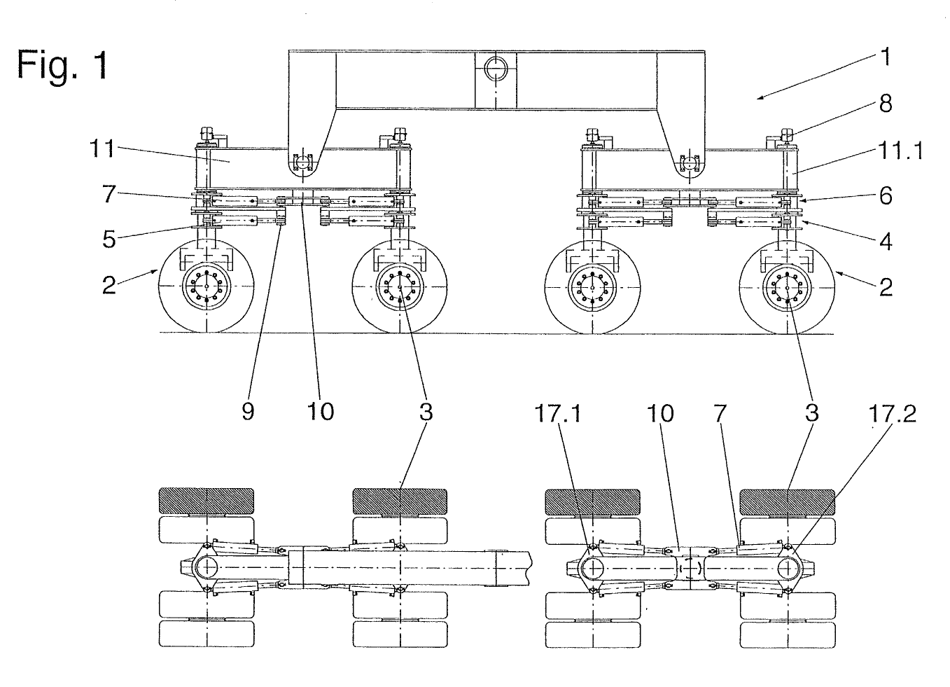

FIGS. 1a and 1b show the side view and the top view of an axle group according to the invention as part of a chassis with the axles at a steering angle of 0°. Represented are the chassis 1, the two axle groups 2 with the axles 3, a first lower steering plane 4 with the steering cylinders 5, the second upper steering plane 6 with the steering cylinders 7 and the rotational angle sensors 8, by means of which the degree of steering movement can be detected. The fixed point bearing 9 of the steering cylinders 5 in the steering plane 4 are situated on the projecting lever arm 17. The fixed point bearing 10 of the steering cylinders 7 on the upper steering plane 6 are situated on the vehicle frame, that is on the beam 11.

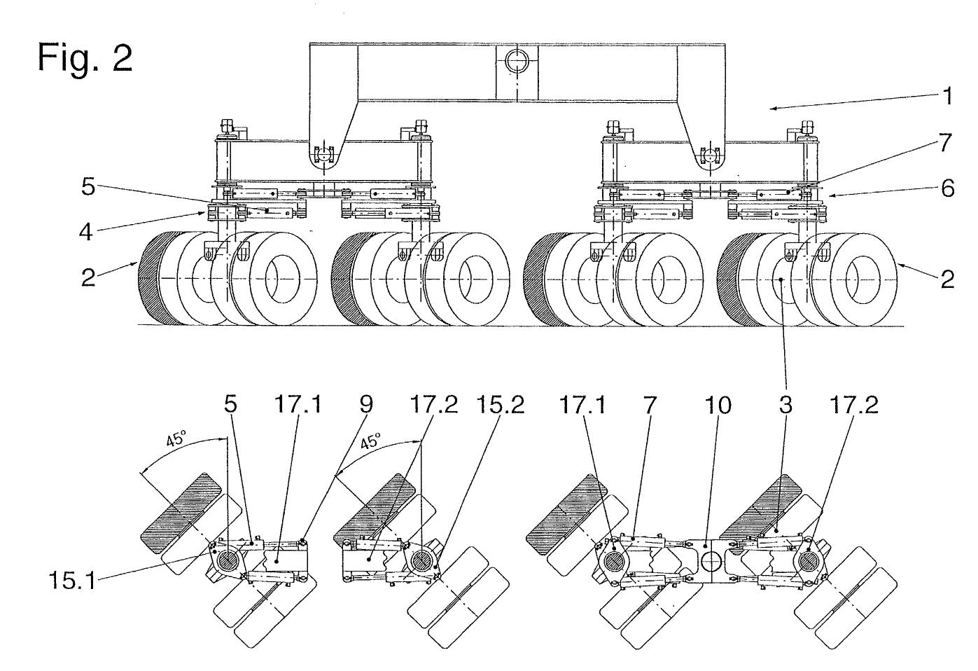

FIGS. 2a and 2b likewise show a side view and top view of the axle group according to FIGS. 1a and 1b, the axles in this case presenting a steering angle of 45°. Here too, the chassis 1, the two axle groups 2 with the axles 3 and the steering planes 4 and 6 are represented. The first steering plane 4 is swiveled through 45° by means of the steering cylinders 5. The steering cylinders 7 in the second upper steering plane 6 remain in their 0° position. In this way a steering angle in the order of ±45° is achieved, which is sufficient to meet normal requirements for the maneuverability of transport vehicles and crane carriers.

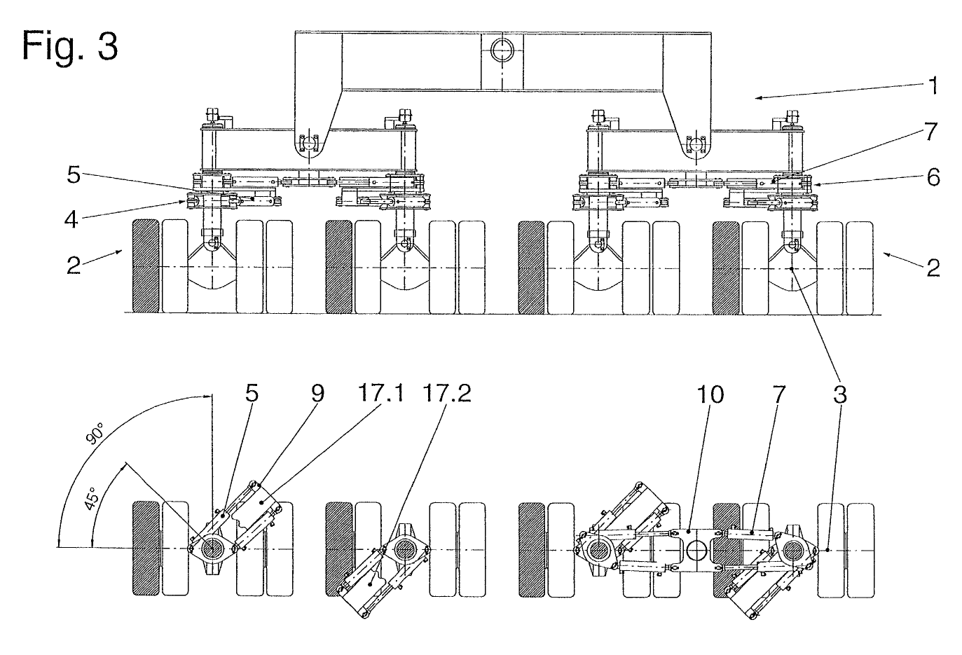

FIGS. 3a and 3b show the 90° steering angle of the chassis in a side view and top view of an axle group. Identical parts are numbered identically. The lower steering plane 4 is held in its swiveled position by the steering cylinders 5. The second upper steering plane 6 is likewise swiveled through 45° by the steering cylinders 7. By actuating both steering planes the steering angles of the axles add up to a ±90° steering angle.

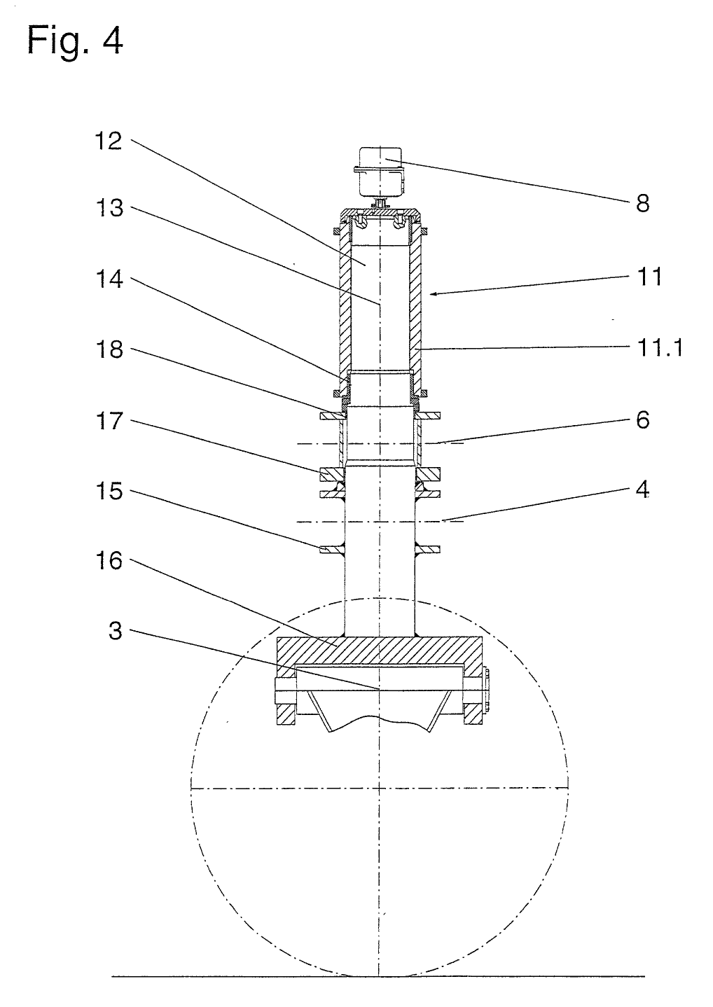

FIG. 4 shows a section through the shaft 12 in the area of the swiveling axle. The vertical swiveling axle 13 with bearing bushes 14 can be seen. The control arms 15 of the lower steering plane 4 and the axle bearing 16 are fixed to the shaft 12. The horizontally projecting lever arm 17 is supported in the bearing bushes 18 on the shaft 12. When the second steering plane 6 is actuated, the projecting lever arm 17 swivels about the vertical swiveling axle, together with the articulations of the hydraulic cylinders 5 for adjustment of the first swivel plane.

The invention is not limited by the embodiments described above which are presented as examples only but can be modified in various ways within the scope of protection defined by the appended patent claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A hydraulic steering device for a vehicle chassis, having plural axles steerable between longitudinal and transverse drive positions, each axle being affixed to an associated shaft carried on the vehicle, the shaft being supported for pivoting about a perpendicular swiveling axis, said device comprising:
a control arm mountable to said shaft;
a lever arm rotatably mounted on said shaft coaxially with said control arm;
an actuator connected to said control arm for rotating said shaft through an arc of movement;
another actuator connected to said lever arm for rotating said lever arm through another arc of movement; and
said lever arm being articulated to said control arm such that rotative movement of said lever arm is replicated in said control arm whereby an angular rotation of said shaft is effected which is a cumulative of said arc and another arc movements.

2. A hydraulic steering device for a vehicle chassis, having plural axles steerable between longitudinal and transverse drive positions, each axle being affixed to an associated shaft carried on the vehicle, the shaft being supported for pivoting about a perpendicular swiveling axis, said device comprising:
a control arm mountable to said shaft;
a lever arm, said lever arm having a first end rotatably mountable on said shaft;
a first steering cylinder, a first end of said first steering cylinder being affixed to said control arm, an opposite end of said first steering cylinder being affixed to an opposite free end of said lever arm whereby a rotation of said lever arm effects accompanying rotation of said control arm; and
a second steering cylinder, a first end of said second cylinder being affixed to the first end of said lever arm, an opposite end of said second cylinder being mountable to a structure member of the chassis, an actuation of said first steering cylinder rotating the shaft through a first arc of movement, an actuation of said second steering cylinder rotating said lever arm on the shaft through a second arc of movement.

3. A hydraulic steering device according to claim 2, wherein a cumulative of said first and second arcs of movement is substantially 90°.

4. A hydraulic steering device according to claim 2, wherein the lever arm projects from said shaft in a plane parallel to a first horizontal lower steering plane, said chassis structure member being a beam, said opposite end of said second cylinder being mountable to said beam in a second horizontal upper steering plane which is parallel to said first steering plane, the shaft rotation in said arc of movement and the lever arm rotation on said shaft each being substantially 45°.

5. A hydraulic steering device according to claim 4, wherein the control arm includes two wing flange members axially spaced on the shaft, the wing flange members being disposed symmetrically at opposite sides of the shaft, the first end of said lever arm including a collar loose on said shaft,
a third steering cylinder, a first end of said third steering cylinder being mountable to the wing members at one side of said shaft, the first end of said first steering cylinder being mountable to the wing members at an opposite side of said shaft, an opposite end of said third steering cylinder being mountable to said opposite free end of said lever arm, the opposite end mounting of said first and third steering cylinders to said lever arm being at respective ones of opposite side locations on the lever arm; and
a fourth steering cylinder, a first end of said fourth steering cylinder being mountable to said collar at one side thereof, an opposite first end of said fourth cylinder being mountable to said chassis beam.
